(19) United States
(12) Patent Application Publication
(10) Pub. No.: US 2020/0013247 A1
(43) Pub. Date: Jan. 9, 2020

(54) METHOD FOR CHECKING THE IDENTITY OF THE OCCUPANTS OF AN AIRCRAFT AND DEVICE FOR ITS IMPLEMENTATION

(71) Applicant: Airbus SAS, Blagnac (FR)

(72) Inventor: Diego ALONSO TABARES, Toulouse (FR)

(21) Appl. No.: 16/506,642

(22) Filed: Jul. 9, 2019

(30) Foreign Application Priority Data
Jul. 9, 2018 (FR) 1856284

(51) Int. Cl. G07C 9/00; G06K 9/00

(52) U.S. Cl. CPC G07C 9/00111; G06K 9/00369; G07C 9/00134; G07C 9/00031

(57) ABSTRACT

A method for checking the identity of the occupants of an aircraft disembarking at an arrival territory for reducing or dispensing with checking operations on the ground when the flight arrives. The method comprises, for each occupant, a step of collecting at least one occupant identifier by way of at least one checking system positioned in the aircraft when the occupants are present in the aircraft, a step of transmitting the collected occupant identifier to a processing unit, and a step of determining, by way of the processing unit, a decision to authorize or to prohibit entry to the arrival territory on the basis of admissibility and/or exclusion criteria from an occupant file and from the collected occupant identifier. Also a device for implementing the identity-checking method.

### CROSS-REFERENCES TO RELATED APPLICATIONS

This application claims the benefit of the French patent application No. 1856284 filed on Jul. 9, 2018, the entire disclosures of which are incorporated herein by way of reference.

### FIELD OF THE INVENTION

The present application relates to a method for checking the identity of the occupants of an aircraft, and to a device for implementing same.

### BACKGROUND OF THE INVENTION

The occupants of an aircraft, when they disembark in a new country, are generally guided to border control stations where their identity documents are checked by security agents.

In a first mode of operation, the security agent checks the identity document of each occupant of the aircraft. For each of them, he may also take fingerprints, take a photo or ask certain questions to verify the identity of the occupant. If the security agent confirms the check, he allows the checked occupant to enter the territory. If not, the checked occupant is not authorized to enter the territory, and he may be subjected to an additional check.

In this first mode of operation, the checking procedure may prove lengthy and depend on the number of security agents and on the flow of people to be checked. To reduce the checking time for certain occupants of the aircraft, some stations are dedicated to priority occupants.

In a second mode of operation, part of the checking procedure is automated and performed by checking terminals linked to a centralized system. These checking terminals are configured so as to allow the occupants of the aircraft to scan their identity documents and possibly so as to take at least one photo of each checked person, ask them questions and record their responses. In addition, the checking terminal gives each checked occupant an identifier, such as a paper comprising a barcode or a matrix code. For each checked occupant, the data read by the checking terminal and associated with the identifier are transmitted in real time to the centralized system, which carries out the check by comparing the data read by the checking terminal with those from an occupant file stored in the centralized system and storing admissibility and/or exclusion criteria. At the end of this step, the centralized system associates a decision to authorize or to prohibit entry to the territory with each identifier. After passing this terminal, each checked occupant has to go to a control station. At each control station, a security agent scans the identifier of the checked occupant that has been delivered by the checking terminal and views the authorization or prohibition decision taken by the centralized system, associated with the scanned identifier, and authorizes or does not authorize the checked occupant to enter the territory depending on this decision.

Even though part of it is automated, the checking procedure remains relatively lengthy.

In a third mode of operation, the checking procedure is completely automated. In this third mode of operation, the control station comprises an automatic barrier at which the checked occupant of the aircraft presents the identifier that the checking terminal has given him Depending on the authorization or prohibition decision, associated with the identifier, taken by the centralized system, the barrier opens or does not open. If the barrier opens, the checked occupant of the aircraft is able to enter the territory. If the barrier does not open, the checked occupant of the aircraft is not authorized to enter the territory, and he is taken aside by a security agent for additional checks.

Even though this checking step is automated, the duration thereof may prove lengthy depending on the flow of people to be checked.

In a fourth mode of operation, the checking step is performed before boarding the aircraft. Even though this fourth mode of operation makes it possible to dispense with the checking step when the flight arrives and with the associated time, it increases the checking time before boarding.

The present invention aims to rectify all or some of the drawbacks from the prior art.

### SUMMARY OF THE INVENTION

To this end, one subject of the invention is a method for checking the identity of the occupants of an aircraft disembarking at an arrival territory. According to the invention, the method comprises, for each occupant, a step of collecting at least one occupant identifier specific to the occupant by way of at least one checking system positioned in the aircraft when the occupants are present in the aircraft, a step of transmitting the collected occupant identifier to a processing unit, and a step of determining, by way of the processing unit, a decision to authorize or to prohibit entry to the arrival territory on the basis of admissibility and/or exclusion criteria from an occupant file and from the collected occupant identifier.

As some of the operations of the identity check are performed during the flight, the operations of checking the occupants of an aircraft when the flight arrives are reduced, or even dispensed with.

According to another feature, the processing unit generates a decision file associating an occupant identifier and a decision to authorize or to prohibit entry to the arrival territory for each occupant, which decision file is transmitted to members of the flight crew of the aircraft.

According to another feature, for an occupant seated on a passenger seat having a passenger seat number, the collected occupant identifier is transmitted to the processing unit associated with the passenger seat number of the occupant.

In a first mode of operation, the decision file is presented in the form of a list indicating, for each passenger seat, the decision to authorize or to prohibit entry to the arrival territory.

In a second mode of operation, the decision file is presented in the form of a visual, displayed on a display system, the passenger seats associated with a decision to authorize entry to the arrival territory being shown in a first way, the passenger seats associated with a decision to prohibit entry to the arrival territory being shown in a second way different from the first.

Another subject of the invention is a device for implementing a method for checking the identity of the occupants of an aircraft disembarking in an arrival territory, characterized in that the device comprises at least one checking system positioned in the aircraft and configured so as to collect at least one occupant identifier specific to an occupant and a processing unit configured so as to determine, for each occupant, a decision to authorize or to prohibit entry to the arrival territory on the basis of admissibility and/or exclusion criteria from an occupant file and from the collected occupant identifier.

According to one feature, the processing unit is positioned in the aircraft and configured so as to communicate with each checking system present in the aircraft and a centralized system present on the ground storing the occupant file.

According to another feature, the device comprises at least one display system configured so as to display, for each occupant, the decision to authorize or to prohibit entry to the arrival territory taken by the processing unit.

According to a first variant, the device comprises at least one first mobile trolley, equipped with at least one checking system and configured so as to move in the aircraft.

According to a first configuration, the trolley is configured so as to travel on a floor of the aircraft.

According to a second configuration, the trolley is configured so as to move in translation along at least one rail positioned above the passenger seats of the aircraft.

According to a second variant, the device comprises a plurality of fixed checking systems, positioned in front of each occupant seated on a passenger seat of the aircraft.

According to another feature, the device comprises at least one second trolley equipped with a barrier able to move between a retracted position, in which it allows an occupant to pass, and an extended position, in which it prevents an occupant from passing, said second trolley comprising a reading system configured so as to read at least one occupant identifier of an occupant and a control module configured so as to communicate with the processing unit and so as to control the position of the barrier depending on the occupant identifier read by the reading system and on the decision to authorize or to prohibit entry to the given territory taken by the processing unit.

### BRIEF DESCRIPTION OF THE DRAWINGS

Other features and advantages will emerge from the following description of the invention, which description is given purely by way of example with reference to the appended drawings, in which:

FIG. 1 is a schematic depiction of the inside of an aircraft equipped with a system for checking the identity of the occupants of the aircraft, which illustrates one embodiment of the invention,

FIG. 2 is a perspective view of a mobile identity-checking system, which illustrates a first embodiment of the invention,

FIG. 3 is a perspective view of a mobile access barrier, which illustrates one embodiment of the invention,

FIG. 4 is a schematic side-on depiction of a fixed identity-checking system, which illustrates a second embodiment of the invention,

FIG. 5 is a schematic front-on depiction of an identity-checking system, which illustrates a third embodiment of the invention, and

FIG. 6 is a schematic side-on depiction of the identity-checking system able to be seen in FIG. 5.

### DETAILED DESCRIPTION OF THE PREFERRED EMBODIMENTS

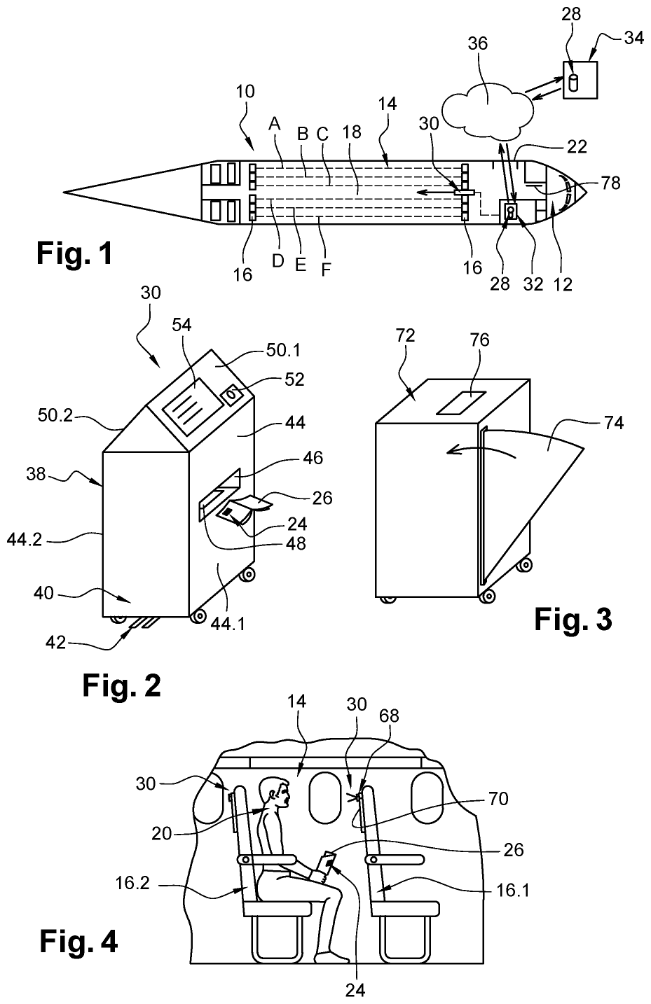

FIG. 1 schematically shows an aircraft 10 having a cockpit 12 and a passenger cabin 14 in which passenger seats 16 are positioned in a plurality of rows A to F positioned on either side of at least one gangway 18. The rows A to F of passenger seats 16 are oriented parallel to a longitudinal direction corresponding to the direction that extends between the front and rear points of the aircraft 10. During operation, the aircraft 10 accommodates passengers and members of the flight crew, who are called occupants 20 hereinafter (able to be seen in FIGS. 4 and 6). The aircraft 10 also comprises an opening 22 for allowing the occupants 20 to enter inside the aircraft 10 or to leave it.

Each of the occupants 20 has at least one unique occupant identifier 24 that is specific to him. For the present application, an occupant identifier 24 comprises at least one of the following elements or a combination of the following elements: an alphanumeric code, a barcode, a matrix code, a photo, an electronic marker such as for example an RFID chip, a biometric element of the occupant, such as, for example, a fingerprint, an eye scan, a voiceprint or any other information specific to the occupant.

According to one configuration, for each occupant 20, at least one of his occupant identifiers 24 is stored in an identification document 26 (able to be seen in FIGS. 2, 4 and 6), such as, for example, a passport.

To enter a given territory, at least one of the occupant identifiers 24 of each occupant 20 is checked and compared with data from at least one occupant file 28. According to a first configuration, for each flight, the occupant file 28 stores all of the occupant identifiers 24 of the occupants 20 of the aircraft 10 and associates an authorization or a prohibition to enter the given territory with each occupant identifier 24. More generally, the occupant file 28 stores admissibility criteria and/or exclusion criteria for taking a decision to authorize or to prohibit entry to the given territory, for each occupant 20 of the aircraft 10, depending on at least one read occupant identifier and possible additional information provided by the occupant.

A device for checking the identity of the occupants of an aircraft comprises at least one checking system 30, positioned in the aircraft, configured so as to collect at least one occupant identifier specific to an occupant 20 and a processing unit 32 configured so as to determine, for each occupant 20, on the basis of the occupant identifier collected by the one or more checking systems 30, a decision to authorize or to prohibit entry to the given territory.

According to one configuration, when the occupant file 28 associates a decision to authorize or to prohibit entry to the given territory with each occupant identifier, the processing unit 32 compares, for each occupant, the read occupant identifier with the occupant identifiers stored in the occupant file 28. If the occupant identifier is the same as an occupant identifier stored in the occupant file 28 and associated with a decision to authorize entry to the given territory, then the processing unit 32 associates a decision to authorize entry to the given territory with the read occupant identifier, and the occupant 20 possessing this read occupant identifier is authorized to enter the given territory. In the opposite case, if the read occupant identifier does not correspond to any of the occupant identifiers stored in the occupant file 28 or is the same as an occupant identifier stored in the occupant file 28 associated with a decision to prohibit entry to the given territory, then the processing unit 32 associates a decision to prohibit entry to the territory with the read occupant identifier, and the occupant 20 possessing this read occupant identifier is not authorized to enter the given territory without an additional intervention from a security agent on the ground when the flight arrives at the given territory.

More generally, the processing unit 32 determines a decision to authorize or to prohibit entry to the given territory on the basis of admissibility criteria and/or exclusion criteria from the occupant file 28 and from the one or more occupant identifiers collected by a checking system 30. Thus, if the one or more occupant identifiers of a given occupant 20 collected by the checking system 30 comply with the admissibility criteria, then the processing unit 32 associates a decision to authorize entry to the given territory with this given occupant. In the opposite case, if at least one of the occupant identifiers of a given occupant collected by the checking system 30 does not comply with the admissibility criteria or corresponds to one of the exclusion criteria, then the processing unit 32 associates a decision to prohibit entry to the given territory with this given occupant.

Depending on the one or more occupant identifiers to be read, the checking system 30 comprises a single reading system or a combination of reading systems including, in particular, a camera, an identification document reading system, an RFID chip reader, a biometric element reader, a microprocessor or other devices.

According to one configuration, the processing unit 32 is positioned in the aircraft 10 and it is configured so as to communicate with each checking system 30 present in the aircraft 10 and a centralized system 34 present on the ground. Each checking system 30 is linked to the processing unit 32 by a wired or wireless communication network operating in accordance with a given communication protocol. The processing unit 32 is linked to the centralized system 34 by a wireless communication network 36 operating in accordance with a given communication protocol. This wireless communication network 36 may operate temporarily, in particular, when the aircraft is on the ground.

According to one embodiment, the centralized system 34 of a given territory comprises a plurality of occupant files 28, one for each aircraft 10 landing in the given territory, each occupant file 28 being associated with an aircraft identifier. The centralized system 34 and the processing unit 32 of an aircraft are configured so as to exchange the occupant file 28 associated with the identifier of the aircraft 10.

According to a first embodiment, the processing unit 32 is a dedicated computer, equipped with software configured, inter alia, so as to perform a comparison between an occupant identifier read by one of the checking systems 30 and the admissibility and/or exclusion criteria stored in the occupant file 28, and make a decision to authorize or to prohibit entry to the given territory depending on the comparison.

According to a second embodiment, the function of the processing unit 32 is provided by a computer that is already present in the aircraft 10 and used for other functions, equipped with software configured, inter alia, so as to perform a comparison between an occupant identifier read by one of the checking systems 30 and the admissibility and/or exclusion criteria stored in the occupant file 28, and make a decision to authorize or to prohibit entry to the given territory depending on the comparison.

The occupant file 28 may be stored in the processing unit 32 and/or in the centralized system 34.

According to a first variant able to be seen in FIGS. 2, 5 and 6, the aircraft comprises at least one first trolley 38, 56 equipped with at least one checking system 30, configured so as to move in the aircraft 10.

According to a first configuration illustrated by FIG. 2, the first trolley 38 is configured so as to travel on a floor of the aircraft. It comprises a rolling frame 40 configured so as to travel in a gangway 18 of an aircraft 10 and equipped with an immobilization mechanism 42. This rolling frame 40 supports a hood 44 having two opposite lateral faces 44.1, 44.2 that are oriented towards the passenger seats 16, each having a slot 46 in which there is positioned a reading system 48 for reading an identification document 26, such as a passport, and two inclined upper faces 50.1, 50.2, oriented towards the passenger seats 16, each having a reader 52 for reading a biometric element and a touchscreen 54 configured so as to display questions and allow responses to be entered. As a variant, the screen 54 is supplemented by a keypad for entering the responses.

The reader 52 for reading a biometric element and the touchscreen 54 may be integrated into an apparatus able to be detached from the first trolley 38, which may thus be held by the occupants 20 and passed from one occupant 20 to another.

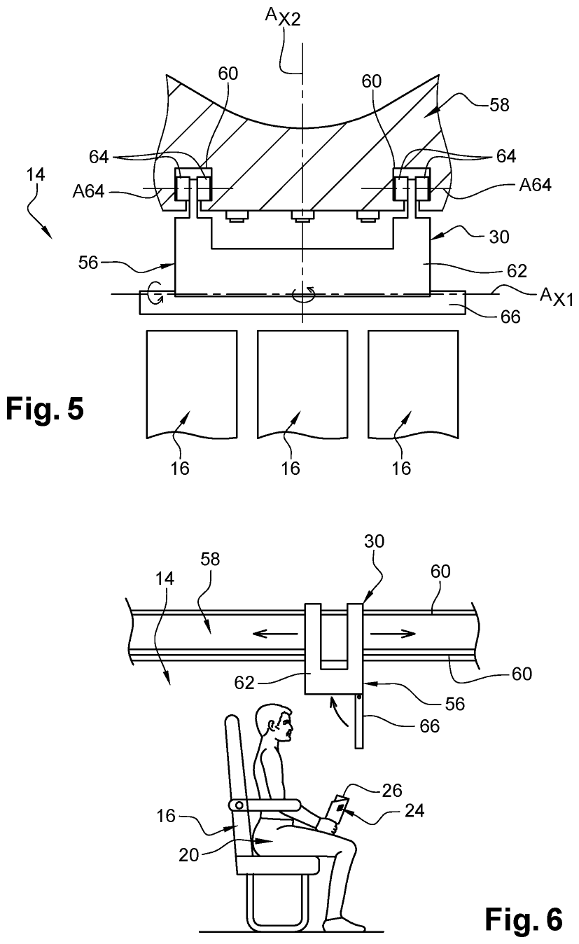

According to a second configuration illustrated by FIGS. 5 and 6, the first trolley 56 is configured so as to move in translation along at least one rail positioned above the passenger seats 16. According to this second embodiment, the aircraft 10 comprises, above the passenger seats 16, luggage compailinents 58 aligned parallel to the longitudinal direction. The luggage compartments 58 have a plurality of grooves 60, for example with a T-shaped cross section, each forming a rail. Rails may thus be provided above the rows of passenger seats 16 positioned next to the windows and/or above the rows of passenger seats 16 positioned between two gangways 18. In addition, the first trolley 56 comprises a base 62 that has rollers 64 configured so as to pivot about axes of rotation A 64 and travel in the grooves 60. According to this second configuration, the grooves 60, the base 62 and the rollers 64 are configured such that the first trolley 56 is suspended underneath the rails. This first trolley 56 comprises, in addition to the base 62, a retractable part 66 able to move in relation to the base 62 between a folded position, able to be seen in FIG. 5, in which the retractable part 66 is in the horizontal position, pressed against the base 62, and a deployed position, able to be seen in FIG. 6, in which the retractable part 66 is in the vertical position, perpendicular to the base 62. The retractable part 66 comprises at least one checking system 30, such as, for example, a camera.

According to one configuration able to be seen in FIG. 5, the retractable part 66 is able to move in relation to the base and is able to pivot about a first pivot axis Ax1, which is horizontal and perpendicular to the longitudinal direction, and about a second pivot axis Ax2, which is vertical.

According to this second configuration, the first trolley 56 is able to move above the rows of passenger seats 16 and is configured so as to stop between two passenger seats 16, the retractable part 66 being in the folded position when the first trolley 56 moves in translation above the passenger seats 16 and being in the deployed position when the first trolley 56 is immobilized such that the retractable part 66 is positioned in front of the head of an occupant 20 seated on a passenger seat 16.

Regardless of the configuration, the first trolleys 38, 56 may move manually or be motorized or move autonomously.

Each first trolley 38, 56 may comprise, in addition to the one or more checking systems 30, at least one battery so as to make it autonomous in terms of energy, at least one communication module for communicating with the processing unit 32, and at least one microprocessor for controlling the checking system 30, the communication module and the movements of the first trolley 38, 56.

According to a third configuration, the checking system 30, and possibly a reader of a biometric element accompanied by a touchscreen, are integrated into a portable apparatus that is able to be held by the occupants and passed from one occupant to another.

One and the same aircraft 10 may comprise at least one first trolley 38 as illustrated in FIG. 2, at least one first trolley 56 as illustrated in FIGS. 5 and 6 and/or a portable apparatus incorporating at least one checking system 30.

According to a second variant, able to be seen in FIG. 4, the aircraft 10 comprises a plurality of fixed checking systems 30, each of these being positioned in front of each passenger seat 16.1, 16.2 (able to be seen in FIG. 4). According to one configuration, when a first passenger seat 16.1 is positioned in front of a second passenger seat 16.2, this first passenger seat 16.1 comprises at least one checking system 30 positioned behind the backrest of the first passenger seat 16.1. By way of example, the checking system 30 is a camera 68 present above a touchscreen 70. According to this second variant, the devices that are already present behind the backrests of the passenger seats 16.1, 16.2 may be used to at least partly provide the function of the checking system 30.

According to one embodiment able to be seen in FIG. 3, the device for checking the identity of the occupants 20 of an aircraft 10 comprises at least one second trolley 72 equipped with a barrier 74 able to move between a retracted position, in which it allows an occupant to pass, and an extended position, in which it prevents an occupant from passing. This second trolley 72 is equipped with a reading system 76 configured so as to read at least one of the occupant identifiers 24 of each occupant 20, a control module configured so as to communicate with the processing unit 32, so as to control the position of the barrier 74 depending on the occupant identifier read by the reading system 76 and on the decision to authorize or to prohibit entry to the given territory taken by the processing unit 32.

According to one mode of use, this second trolley 72 is positioned at an opening 22 of the aircraft inside or outside the aircraft. The device for checking the identity of the occupants of an aircraft may comprise as many second trolleys 72 as there are openings 22. According to another mode of use, at least one second trolley 72 is positioned inside the aircraft and makes it possible to separate two areas of the cabin.

According to one embodiment, the device for checking the identity of the occupants of an aircraft also comprises at least one display system 78 configured so as to display, for each occupant 20, the decision to authorize or to prohibit entry to the given territory taken by the processing unit 32.

The method for checking the identity of the occupants of an aircraft that is intended to enter an arrival territory is now described with reference to the various figures.

At the end of boarding, the doors of the aircraft are closed, and all of the occupants of the aircraft are each seated on the passenger seat that has been assigned to them.

One at a time, all of the occupants 20 of the aircraft present their identification documents 26 to one of the checking systems 30 present in the aircraft. According to the first variant, the one or more checking systems 30 are moved in the aircraft 10 so as to be positioned next to each occupant 20. According to the second variant, each occupant 20 uses the checking system 30 that is dedicated to him, present in front of him in the case of the passengers.

Regardless of the variant, when the occupants 20 are present in the aircraft, for each of them, the method for checking the identity of the occupants of the aircraft comprises a step of collecting at least one occupant identifier 24 specific to the occupant 20 by way of at least one checking system 30, and a step of transmitting the collected occupant identifier to the processing unit 32.

In one nonlimiting mode of operation, for each occupant 20, the collected occupant identifier is transmitted to the processing unit 32 associated with the seat number 16 of the occupant 20.

Depending on the communication means, the occupant file 28, storing admissibility criteria and/or exclusion criteria for determining a decision to authorize or to prohibit entry to the arrival territory, which occupant file is stored in the centralized system 34 of the arrival territory, is transmitted to the processing unit 32 at the start of the flight, during the flight, or at the end of the flight when the aircraft has landed.

For each occupant 20 of the aircraft 10, the processing unit 32 determines a decision to authorize or to prohibit entry to the arrival territory on the basis of the admissibility criteria and/or of the exclusion criteria from the occupant file 28 and from the one or more collected occupant identifiers 24.

In a first mode of operation, the processing unit generates a decision file, associating an occupant identifier 24 and a decision to authorize or to prohibit entry to the arrival territory for each occupant 20, which decision file is transmitted to the centralized system 34 of the arrival territory. When leaving the aircraft, all of the occupants 20 have to go to a control station. At each control station, a security agent scans the identification document so as to determine the occupant identifier associated with the occupant present in front of him. The security agent views the decision to authorize or to prohibit entry to the arrival territory, associated with the scanned occupant identifier stored in the decision file, and authorizes or does not authorize the checked occupant to enter the arrival territory.

In a second mode of operation, the decision file is transmitted to each second trolley 72 equipped with a barrier 74 and/or to each automatic barrier provided on the ground, as in the prior art. When leaving the aircraft, all of the occupants 20 have to go to a second trolley 72 or an automatic barrier and scan their identification documents 26. Depending on the decision to authorize or to prohibit entry to the arrival territory, stored in the decision file, associated with the scanned occupant identifier, the second trolley 72 or the automatic barrier authorizes or does not authorize the checked occupant to enter the arrival territory.

In a third mode of operation, the processing unit 32 generates a decision file associating an occupant identifier, a seat number and a decision to authorize or to prohibit entry to the arrival territory for each occupant 20, which decision file is transmitted to the members of the flight crew. The decision file may take the form of a list indicating, for each passenger seat, the decision to authorize or to prohibit entry to the arrival territory or a visual, displayed on the display system 78, the passenger seats 16 associated with a decision to authorize entry to the arrival territory being shown in a first way, the passenger seats 16 associated with a decision to prohibit entry to the arrival territory being shown in a second way, different from the first way.

In this third mode of operation, the occupants who are not authorized to enter the arrival territory are located in the aircraft.

If all of the occupants are associated with a decision to authorize entry to the arrival territory, they may all be disembarked without an additional check.

Generally, the passenger cabin is divided into several areas that each comprise at least one opening 22. If all of the occupants of an area under consideration are associated with a decision to authorize entry to the arrival territory, the passengers in this area under consideration may all be disembarked without an additional check. If at least one occupant in an area under consideration is associated with a decision to prohibit entry to the arrival territory, then all of the occupants in the area under consideration are guided to at least one control station, as in the first mode of operation.

As a variant, the members of the flight crew invite each occupant associated with a decision to prohibit entry to the arrival territory to remain seated on their passenger seat 16, while the other occupants are disembarked without an additional check.

According to the invention, as some of the checking operations are performed during the flight, the operations of checking the occupants of an aircraft when the flight arrives are reduced or even dispensed with.

This method for checking the identity of the occupants of an aircraft may be implemented both in new aircraft and in existing aircraft. For an aircraft, it may be implemented for the entire passenger cabin or just in an area of the passenger cabin.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-13. (canceled)

14. A method for checking an identity of occupants of an aircraft disembarking at an arrival territory, comprising:
collecting at least one occupant identifier specific to the occupant by way of at least one checking system positioned in the aircraft when the occupants are present in the aircraft,
transmitting the collected occupant identifier to a processing unit, and
determining, by way of the processing unit, a decision to authorize or to prohibit entry to the arrival territory based on at least one of admissibility or exclusion criteria from an occupant file and from the collected occupant identifier.

15. The method for checking the identity of the occupants of the aircraft according to claim 14, wherein the processing unit generates a decision file associating an occupant identifier and a decision to authorize or to prohibit entry to the arrival territory for each occupant, which decision file is transmitted to members of a flight crew of the aircraft.

16. The method for checking the identity of the occupants of the aircraft according to claim 14, wherein, for an occupant seated on a passenger seat having a passenger seat number, the collected occupant identifier is transmitted to the processing unit associated with the passenger seat number of the occupant.

17. The method for checking the identity of the occupants of the aircraft according to claim 15,
wherein, for an occupant seated on a passenger seat having a passenger seat number, the collected occupant identifier is transmitted to the processing unit associated with the passenger seat number of the occupant, and
wherein the decision file is presented as a list indicating, for each passenger seat, a decision to authorize or to prohibit entry to the arrival territory.

18. The method for checking the identity of the occupants of the aircraft according to claim 15,
wherein, for an occupant seated on a passenger seat having a passenger seat number, the collected occupant identifier is transmitted to the processing unit associated with the passenger seat number of the occupant, and
wherein the decision file is presented as a visual, displayed on a display system, the passenger seats associated with a decision to authorize entry to the arrival territory being shown in a first way, the passenger seats associated with a decision to prohibit entry to the arrival territory being shown in a second way, different from the first way.

19. A device for implementing a method for checking an identity of occupants of an aircraft disembarking in an arrival territory, the method including the steps of:
collecting at least one occupant identifier specific to the occupant by way of at least one checking system positioned in the aircraft when the occupants are present in the aircraft,
transmitting the collected occupant identifier to a processing unit, and
determining, by way of the processing unit, a decision to authorize or to prohibit entry to the arrival territory based on at least one of admissibility or exclusion criteria from an occupant file and from the collected occupant identifier,
the device comprising:
at least one checking system positioned in the aircraft and configured so as to collect at least one occupant identifier specific to an occupant, and
a processing unit configured so as to determine, for each occupant, a decision to authorize or to prohibit entry to the arrival territory based on at least one of admissibility or exclusion criteria from an occupant file and from the collected occupant identifier.

20. The device according to claim 19, wherein the processing unit is positioned in the aircraft and configured so as to communicate with each checking system present in the aircraft and a centralized ground based system storing the occupant file.

21. The device according to claim 19, further comprising at least one display system configured so as to display, for each occupant, the decision to authorize or to prohibit entry to the arrival territory taken by the processing unit.

22. The device according to claim 19, further comprising at least one first mobile trolley, equipped with at least one checking system and configured so as to move in the aircraft.

23. The device according to claim 22, wherein the trolley is configured to travel on a floor of the aircraft.

24. The device according to claim 22, wherein the trolley is configured to move in translation along at least one rail positioned above the passenger seats of the aircraft.

25. The device according to claim 19, wherein the device comprises a plurality of fixed checking systems, positioned in front of each occupant seated on a passenger seat of the aircraft.

26. The device according to claim 19, wherein the device comprises at least one second trolley equipped with a barrier able to move between a retracted position, in which the barrier allows an occupant to pass, and an extended position, in which the barrier prevents an occupant from passing, said second trolley comprising a reading system configured to read at least one occupant identifier of an occupant and a control module configured to communicate with the processing unit and to control the position of the barrier depending on the occupant identifier read by the reading system and on the decision to authorize or to prohibit entry to the given territory taken by the processing unit.
